(19) United States
(12) Patent Application Publication
(10) Pub. No.: US 2015/0042782 A1
(43) Pub. Date: Feb. 12, 2015

(54) IMAGE PROCESSING APPARATUS, IMAGING APPARATUS, MICROSCOPE SYSTEM, IMAGE PROCESSING METHOD, AND COMPUTER READABLE RECORDING MEDIUM

(71) Applicant: OLYMPUS CORPORATION, Tokyo (JP)

(72) Inventor: Shunichi KOGA, Tokyo (JP)

(21) Appl. No.: 14/452,151

(22) Filed: Aug. 5, 2014

(30) Foreign Application Priority Data
Aug. 9, 2013 (JP) 2013-166953

(51) Int. Cl. G02B 21/36; H04N 9/67; H04N 9/04; H04N 9/64

(52) U.S. Cl. CPC G02B 21/367; H04N 9/646; H04N 9/67; H04N 9/045
USPC 348/79; 348/242; 348/234

(57) ABSTRACT

An image processing apparatus includes: an image acquiring unit that acquires an image signal of a monochromatic image acquired by imaging a subject and an image signal of a color image acquired by imaging the subject, the color image having at least a plurality of pieces of color information; and an interpolation processing unit that generates an interpolated image by interpolating color information missing at each pixel forming the color image, based on a signal value of each pixel forming the monochromatic image.

### CROSS-REFERENCE TO RELATED APPLICATIONS

This application is based upon and claims the benefit of priority from Japanese Patent Application No. 2013-166953, filed on Aug. 9, 2013, the entire contents of which are incorporated herein by reference.

### BACKGROUND

1. Technical Field

The disclosure relates to an image processing apparatus, an imaging apparatus, a microscope system, an image processing method, and a computer readable recording medium, for processing an image captured via a color filter.

2. Related Art

When a color image is acquired by using a solid state imaging element such as a CCD image sensor, imaging is performed by arranging a color filter, which has, for example, three colors, red (R), green (G), and blue (B), in front of a light receiving surface of photodiodes (pixels) included in the solid state imaging element. In this imaging method, because only image information (color information) on one color is able to be acquired for one pixel, the image as a whole becomes the so-called mosaic image arranged of pixels having color information of colors corresponding to their positions. For such a mosaic image, by interpolating color information lacking in each pixel, a color image, in which each pixel has all of color components (for example, three colors), is able to be generated. Such a process is sometimes called “demosaicing process”.

As an interpolation process, for example, linear interpolation is known, in which: for a pixel of interest, an average value of pixel values of plural pixels around the pixel of interest having color information of a color that is the same as that of color information to be interpolated is calculated; and this average value is treated as that color information of the pixel of interest. However, in the linear interpolation, because the color information is estimated such that a change becomes smooth by finding the simple average of the color information of the surrounding pixels without considering directionality of the color information at the pixel of interest, false colors are generated at edge portions, fine portions, and the like.

To avoid such a situation, Japanese Patent No. 4352331 discloses a technique of reducing false colors at edge portions, fine portions, and the like by determining an interpolation direction from a correlation value of color information of plural pixels around a certain pixel in a mosaic image and performing interpolation based on color information of pixels arranged in the determined interpolation direction.

### SUMMARY

In accordance with some embodiments, an image processing apparatus, an imaging apparatus, a microscope system, an image processing method, and a computer readable recording medium are presented.

In some embodiments, an image processing apparatus includes: an image acquiring unit that acquires an image signal of a monochromatic image acquired by imaging a subject and an image signal of a color image acquired by imaging the subject, the color image having at least a plurality of pieces of color information; and an interpolation processing unit that generates an interpolated image by interpolating color information missing at each pixel forming the color image, based on a signal value of each pixel forming the monochromatic image.

In some embodiments, an imaging apparatus includes: the above-described image processing apparatus; and an imaging unit that generates and outputs the image signals of the color image and monochromatic image by imaging the subject.

In some embodiments, a microscope system includes: the above-described imaging apparatus; a stage on which the subject is configured to be placed; and an optical system that guides observation light of the subject to the imaging apparatus.

In some embodiments, an image processing method includes the steps of: acquiring an image signal of a monochromatic image acquired by imaging a subject and an image signal of a color image acquired by imaging the subject, the color image having at least a plurality of pieces of color information; and generating an interpolated image by interpolating color information missing at each pixel forming the color image, based on a signal value of each pixel forming the monochromatic image.

In some embodiments, a non-transitory computer readable recording medium is a recording medium having an image processing program recorded therein. The image processing program instructs a processor to perform the steps of: acquiring an image signal of a monochromatic image acquired by imaging a subject and an image signal of a color image acquired by imaging the subject, the color image having at least a plurality of pieces of color information; and generating an interpolated image by interpolating color information missing at each pixel forming the color image, based on a signal value of each pixel forming the monochromatic image.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration of an image processing apparatus according to a first embodiment of the present invention;

FIG. 2 is a flow chart illustrating operations of the image processing apparatus illustrated in FIG. 1;

FIG. 3A is a schematic diagram illustrating a monochrome image;

FIG. 3B is a schematic diagram illustrating a mosaic image;

FIG. 4A is a schematic diagram illustrating R components of an interpolated image;

FIG. 4B is a schematic diagram illustrating G components of the interpolated image;

FIG. 4C is a schematic diagram illustrating B components of the interpolated image;

FIG. 5A is an enlarged photograph illustrating an interpolated image in which a mosaic image has been interpolated by an image processing method according to the first embodiment of the present invention;

FIG. 5B is an enlarged photograph of an interpolated image in which the mosaic image has been interpolated by a conventional image processing method;

FIG. 6 is a schematic diagram illustrating image processing according to a modified example 1-3 of the first embodiment of the present invention;

FIG. 7 is a block diagram illustrating a configuration of an image processing apparatus according to a second embodiment of the present invention;

FIG. 8 is a flow chart illustrating operations of the image processing apparatus illustrated in FIG. 7;

FIG. 9 is a schematic diagram illustrating a configuration of an imaging apparatus according to a third embodiment of the present invention;

FIG. 10 is a schematic diagram illustrating a configuration of an imaging apparatus according to a modified example 3-1 of the third embodiment of the present invention;

FIG. 11 is a schematic diagram illustrating a configuration of an imaging apparatus according to a modified example 3-2 of the third embodiment of the present invention; and

FIG. 12 is a schematic diagram illustrating a configuration of a microscope system according to a fourth embodiment of the present invention.

### DETAILED DESCRIPTION

Hereinafter, embodiments of an image processing apparatus, an imaging apparatus, a microscope system, an image processing method, and a computer readable recording medium according to the present invention will be described in detail with reference to the drawings. The present invention is not limited by these embodiments. Further, in each drawing, illustration is made by appending the same reference signs to the same portions.

### First Embodiment

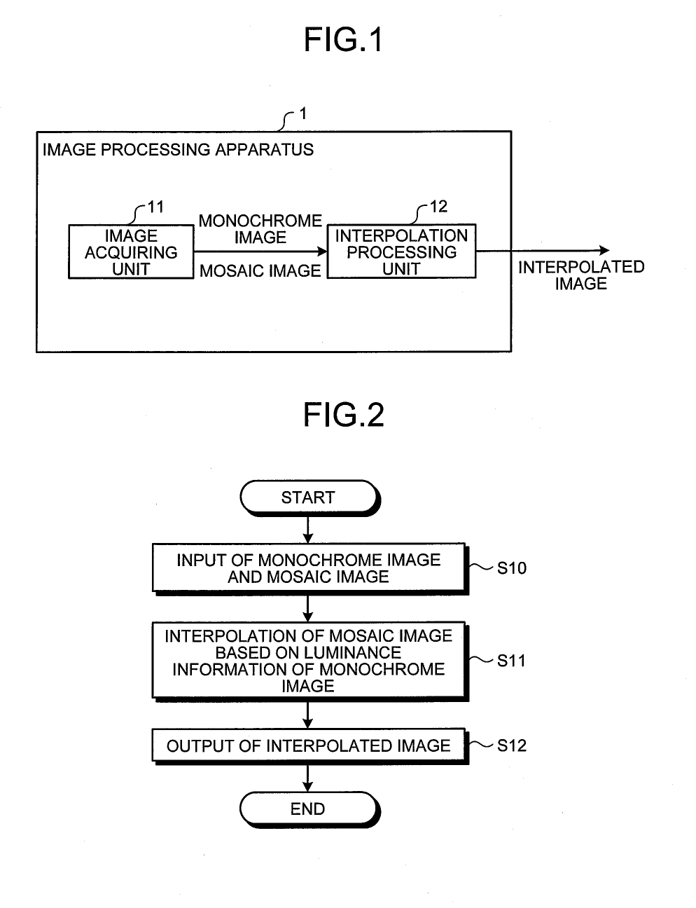

FIG. 1 is a block diagram illustrating a configuration of an image processing apparatus according to a first embodiment of the present invention. As illustrated in FIG. 1, an image processing apparatus 1 according to this first embodiment includes: an image acquiring unit 11 that acquires an image to be subjected to image processing; and an interpolation processing unit 12 that performs interpolation processing on the image.

The image acquiring unit 11 is an interface that inputs and outputs information to and from an external device, such as an imaging device, and the image acquiring unit 11 acquires an image signal of a color image having a plurality of pieces of color information acquired by imaging a subject via a color filter formed of a plurality of colors and an image signal of a monochromatic image acquired by imaging the same subject without the color filter.

The color filter used herein is a color filter in which respective color filters of red, green, and blue, or the like are arranged in a specified arrangement (for example, a Bayer array). The color image captured via such a color filter becomes a so-called mosaic image in which each pixel thereof has image information (hereinafter, referred to as “color information”) of one color. In contrast, the monochromatic image is an image in which each pixel thereof has luminance information only. Hereinafter, the color image captured via the color filter will be referred to as “mosaic image” and the monochromatic image will be referred to as “monochrome image”.

The colors composing the color filter are not limited to the above mentioned three primary colors, red, green, and blue, and may be, for example, complementary colors, yellow, magenta, and cyan, or may be of a multiband of four colors or more. Further, the arrangement of the filters used may be any of various known arrangements, in addition to the Bayer's array.

The mosaic image and monochrome image are preferably images captured by using imaging elements having pixels pitches that are the same as each other. That is, the pixels forming the mosaic image preferably correspond to the pixels forming the monochrome image one-to-one. However, even if the pixels of these images do not have the one-to-one correspondence, as long as a spatial correspondence relationship of the pixels between these images is obtainable, this embodiment is applicable. In this case, the monochrome image is captured by using an imaging element having a pixel pitch less than that of an imaging element used in capturing the mosaic image, to make a pixel density of the monochrome image greater than that of the mosaic image.

The image acquiring unit 11 may acquire the image signals of the mosaic image and monochrome image directly from the imaging apparatus or may acquire them via a network, a storage device, or the like. The type of the imaging apparatus to image the subject is not particularly limited, and for example, may be a microscope apparatus having an imaging function, or a general digital camera.

Further, the image acquiring unit 11 may acquire the image signals in their analog signal state or may acquire the image signals (image data) that have been digitally converted. In the former case, the image acquiring unit 11 digitalizes the image signals and inputs the digitalized image signals to the interpolation processing unit 12.

The interpolation processing unit 12 generates an interpolated image in which each pixel has information on all colors (for example, on the three colors, red, green, and blue) by interpolating, based on a signal value (pixel value) of each pixel forming the monochrome image acquired by the image acquiring unit 11, color information missing in each pixel of the mosaic image.

Next, operations of the image processing apparatus 1 will be described. FIG. 2 is a flow chart illustrating the operations of the image processing apparatus 1.

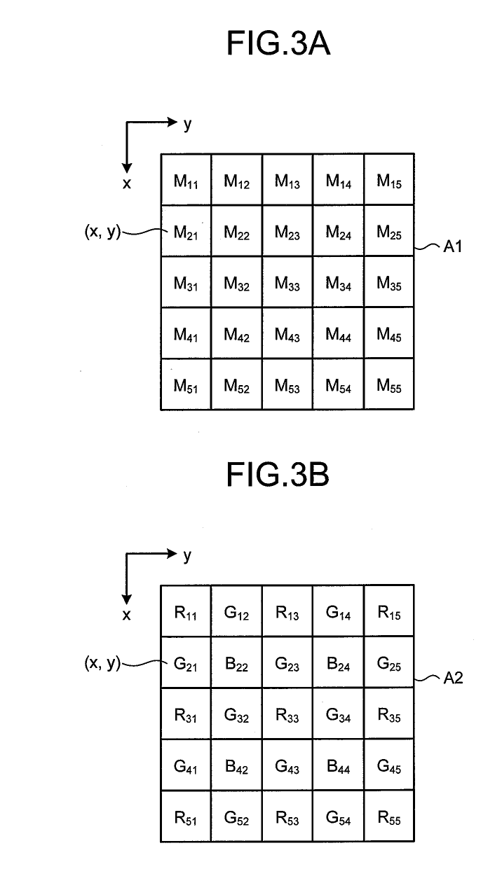

First, at step S10, the image acquiring unit 11 acquires a monochrome image and a mosaic image, in which the same subject image is photographed, and inputs them to the interpolation processing unit 12. FIG. 3A is a schematic diagram illustrating the monochrome image and FIG. 3B is a schematic diagram illustrating the mosaic image. Hereinafter, for the ease of understanding image processing in the first embodiment, a monochrome image A1 and a mosaic image A2, each formed of 5×5=25 pixels, will be described as targets to be processed. Further, hereinafter, coordinates of a pixel forming each of the monochrome image A1 and mosaic image A2 will be denoted as (x, y) (in FIG. 3A and FIG. 3B, 1≦x≦5, 1≦y≦5).

A reference sign M_{xy} shown in a matrix illustrated in FIG. 3A indicates the signal value (pixel value) of the pixel positioned at the coordinates (x, y) of the monochrome image A1. The signal value of each pixel in the monochrome image A1 represents luminance information related to the subject.

Reference signs R_{xy}, G_{xy}, and B_{xy} shown in a matrix illustrated in FIG. 3B indicate the signal values (pixel values) of pixels positioned at the coordinates (x, y) of the mosaic image A2. Of these, the reference sign R_{xy} is a signal value of red color information (hereinafter, also referred to as “R-signal”), the reference sign G_{xy} is a signal value of green color information (hereinafter, also referred to as “G-signal”), and the reference sign B_{xy} is a signal value of blue color information (hereinafter, also referred to as “B-signal”). The mosaic image A2 is, as an example, an image acquired by using a color filter of a Bayer array and each pixel has any of signal values R_{xy}, G_{xy}, and B_{xy}.

At subsequent step S11, the interpolation processing unit 12 generates an interpolated image (demosaic image) in which each pixel has information on all colors, by interpolating, based on the signal values, that is, the luminance information, of the monochrome image A1, color information missing in each pixel of the mosaic image A2. If there is a defective pixel in an imaging element that has generated the monochrome image A1, the signal value of the pixel on the monochrome image A1 corresponding to the defective pixel is interpolated beforehand by a known technique, such as linear interpolation.

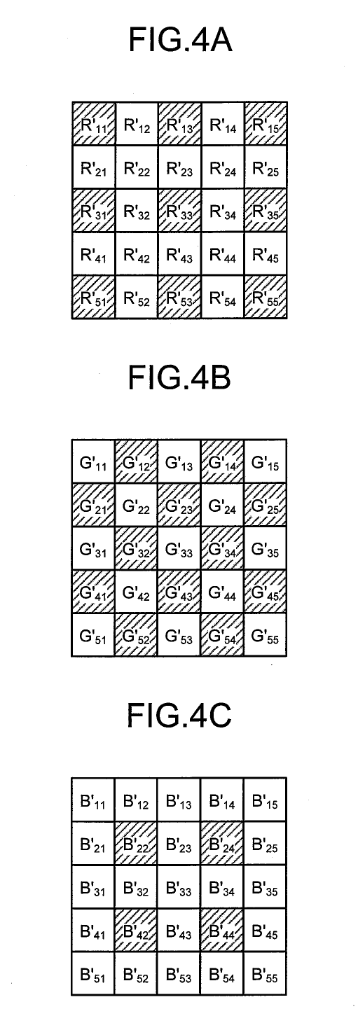

FIG. 4A is a schematic diagram illustrating red color components (hereinafter, referred to as “R-components”) of the interpolated image, FIG. 4B is a schematic diagram illustrating green color components (hereinafter, referred to as “G-components”) of the interpolated image, and FIG. 4C is a schematic diagram illustrating blue color components (“B-components”) of the interpolated image. Reference signs R′_{xy}, G′_{xy}, and B′_{xy} shown in matrices illustrated in FIG. 4A to FIG. 4C respectively represents signal values of R-components, G-components, and B-components at the pixels positioned at the coordinates (x, y) of the interpolated image. In FIG. 4A to FIG. 4C, pixels, for which the signal values R_{xy}, G_{xy}, and B_{xy} have been acquired in the mosaic image A2, are shaded.

The interpolation processing unit 12 uses the signal value M_{xy} of the monochrome image A1 as the G-component of the interpolated image, as-is. That is, G′_{xy}=M_{xy}. Thereby, signal values G′_{xy} at all of the pixels are acquired.

Further, the interpolation processing unit 12 calculates the R-components and B-components of the interpolated image by interpolation processing using the R-signals and B-signals acquired in the mosaic image A2, and the signal values of the monochrome image A1 instead of the R-signals. As the interpolation processing, various known methods are usable, and in this first embodiment, color difference interpolation is performed.

For example, signal values B′₂₂, B′₂₃, B′₃₂, and B′₃₃ of the B-components of the interpolated image are given respectively by Equations (1a) to (1d) below.

$$\begin{matrix} {B}_{22}^{′} = {B}_{22} & ( 1 a ) \\ {B}_{23}^{′} = \frac{( {B}_{22} - {M}_{22} ) + ( {B}_{24} - {M}_{24} )}{2} + {M}_{23} & ( 1 b ) \\ {B}_{32}^{′} = \frac{( {B}_{22} - {M}_{22} ) + ( {B}_{42} - {M}_{42} )}{2} + {M}_{32} & ( 1 c ) \\ {B}_{33}^{′} = \frac{( {B}_{22} - {M}_{22} ) + ( {B}_{24} - {M}_{24} ) + ( {B}_{42} - {M}_{42} ) + ( {B}_{44} - {M}_{44} )}{4} + {M}_{33} & ( 1 d )\end{matrix}$$

That is, like coordinates (2, 2), if the signal value B_{xy} of the color that is the same as the target to be interpolated is acquired in the mosaic image A2, that signal value B_{xy} becomes the signal value B′_{xy} as-is (Equation (1a)). Further, like coordinates (2, 3), if pixels adjacent thereto in an x-direction in the mosaic image A2 have signals of the color that is the same as the target to be interpolated, the signal value B′_{xy} is calculated by color difference interpolation in the x-direction using the signal values of the monochrome image A1 instead of the G-signals (Equation (1b)). Further, like coordinates (3, 2), if pixels adjacent thereto in a y-direction in the mosaic image A2 have signals of a color that is the same as the target to be interpolated, the signal value B′_{xy} is calculated by color difference interpolation in the y-direction using the signal values of the monochrome image A1 instead of the G-signals (Equation (1c)). Further, like coordinates (3, 3), if pixels adjacent thereto in the x-direction and y-direction in the mosaic image A2 respectively have signals of the color that is the same as the target to be interpolated, the signal value B′_{xy} is calculated by color difference interpolation in the x-direction and y-direction using the signal values of the monochrome image A1 instead of the G-signals (Equation (1d)).

The interpolation processing unit 12 calculates the R-components of the interpolated image (signal values R′_{xy}) similarly.

Thereby, the interpolated image, in which all color information missing in the mosaic image A2 has been interpolated, is acquired.

At subsequent step S12, the interpolation processing unit 12 causes a color image to be displayed, by outputting the signals of respective color components forming the interpolate image to an external device such as a display device connected to the image processing apparatus 1. When this is done, the interpolation processing unit 12 may adjust a balance of the colors in the color image by changing output intensities of the R-components, G-components, and B-components color by color.

Thereafter, the operations of the image processing apparatus 1 end.

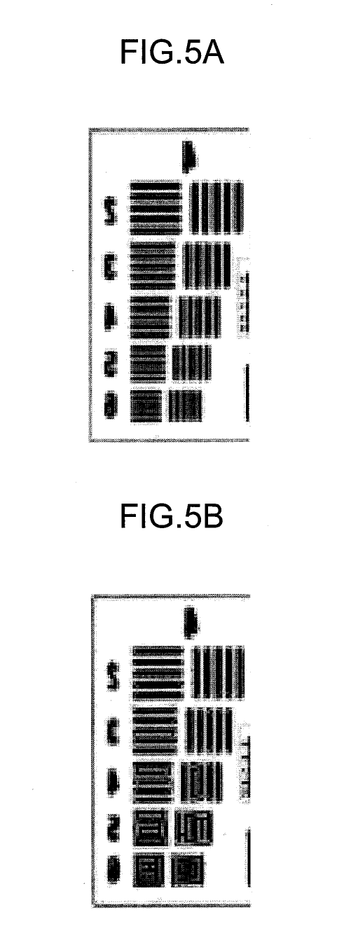

FIG. 5A is an enlarged photograph illustrating an interpolated image generated by an image processing method according to the first embodiment. Further, FIG. 5B is an enlarged photograph illustrating an interpolated image generated by a conventional image processing method and this illustration is made for comparison. Their original mosaic image is an image in which striped patterns, each having vertical and horizontal lines arranged at equal intervals, are arranged such that pitches thereof become narrower from the top of the image to the bottom of the image.

As illustrated in FIG. 5B, in the conventional image processing method, the narrower the pitch of the stripes, the more prominent the generation of false colors and more unclear the vertical and horizontal lines became. In contrast, as illustrated in FIG. 5A, in the image processing method according to the first embodiment, the generation of false colors was able to be reduced sufficiently, and thus even if the pitch of the stripes were made narrow, the vertical and horizontal lines were visually recognizable clearly.

As described above, according to the first embodiment, as G-components in an interpolate image, signal values (luminance information) of the monochrome image A1, in which information on all pixels is available, are used, and thus spatial interpolation processing for the G-components becomes unnecessary. Therefore, errors caused by the interpolation processing of the G-components are able to be suppressed. Further, according to the first embodiment, since R-components and B-components in the interpolated image are interpolated by using the signal values of the monochrome image A1, as compared with a case in which interpolation is performed by using only the signal values of the mosaic image A2, errors caused by the interpolation processing are able to be reduced. Therefore, according to the first embodiment, even at a high frequency band near the Nyquist frequency, generation of false colors is suppressible, and an interpolated image of a higher image quality than before is able to be acquired.

In the first embodiment, the case, in which the color information is lacking because of using the color filter for acquiring the mosaic image, has been described, but the first embodiment is also applicable to, when a defective pixel is present in an imaging element that has generated a mosaic image, interpolation of color information of a pixel on the mosaic image corresponding to the defective pixel.

In the first embodiment, the color information missing in the mosaic image expressed by the three colors, R, G, and B, is calculated, but the method of calculating the missing color information is not limited thereto. Hereinafter, modified examples 1-1 to 1-5 of the method of calculating the color information will be described.

### Modified Example 1-1

Next, the modified example 1-1 of the first embodiment of the present invention will be described.

In the first embodiment, the interpolation process in the RGB color space has been described, but an interpolated image may be generated by performing conversion to the RGB color space after performing interpolation on a mosaic image in a YCbCr color space.

In this case, for a luminance component Y_{xy} of a pixel at coordinates (x, y) in the YCbCr color space, the signal value M_{xy} of the monochrome image A1 is used as-is. That is Y_{Xy}=M_{xy}.

Further, color difference components Cb_{xy} and Cr_{xy} of the pixel at the coordinates (x, y) of the YCbCr color space are calculated from differences between R-signals, B-signals, and G-signals of that pixel in the mosaic image A2 and its surrounding pixels. In this case, in this modified example 1-1, instead of the G-signals, signal values of the monochrome image A1 are used.

For example, color difference components Cb₂₂, Cb₂₃, Cb₃₂, and Cb₃₃ are given by Equations (2a) to (2d) below.

$$\begin{matrix} {Cb}_{22} = {B}_{22} - {M}_{22} & ( 2 a ) \\ {Cb}_{23} = \frac{( {B}_{22} - {M}_{22} ) + ( {B}_{24} - {M}_{24} )}{2} & ( 2 b ) \\ {Cb}_{32} = \frac{( {B}_{22} - {M}_{22} ) + ( {B}_{42} - {M}_{42} )}{2} & ( 2 c ) \\ {Cb}_{33} = \frac{( {B}_{22} - {M}_{22} ) + ( {B}_{24} - {M}_{24} ) + ( {B}_{42} - {M}_{42} ) + ( {B}_{44} - {M}_{44} )}{4} & ( 2 d )\end{matrix}$$

The color difference component Cr_{xy} is similarly calculated based on the R-signals in the mosaic image A2 and the signal values of the monochrome image A1 used instead of the G signals.

A luminance component and color difference components of each pixel interpolated in the YCbCr space as described above are converted into RGB signals by using, for example, known conversion Equations (3a) to (3c) prescribed by ITU-R BT. 601 to thereby acquire each color component of the interpolated image.

R_{xy}=Y_{xy}+1.4022×Cr_{xy} (3a)

G_{xy}=Y_{xy}−0.34414Cb_{xy}−0.71414×Cr_{xy} (3b)

B_{xy}=Y_{xy}+1.77200×Cb_{xy} (3c)

### Modified Example 1-2

Next, the modified example 1-2 of the first embodiment of the present invention will be described.

In this modified example 1-2, when color information missing in a mosaic image is calculated, instead of the color difference interpolation, advanced color plane interpolation (ACPI) is used. As G-components (signal values G′_{xy}) of an interpolated image, similarly to the above described first embodiment, signal values of a monochrome image in which a subject that is the same as that of the mosaic image are used as-is.

In normal ACPI interpolation, to a linear interpolated value calculated from signal values of surrounding pixels of a pixel to be interpolated, a high spatial frequency component at the pixel to be interpolated is added, to thereby calculate a signal value of the pixel to be interpolated. In contrast, in this modified example 1-2, the high spatial frequency component to be added to the linear interpolated value is calculated from signal values M_{xy} of the monochrome image A1.

For example, signal values B′₂₂, B′₂₃, B′₃₂, and B′₃₃ of B-components of the interpolated image are given by Equations (4a) to (4d) below.

$$\begin{matrix} {B}_{22}^{′} = {B}_{22} & ( 4 a ) \\ {B}_{23}^{′} = \frac{{B}_{22} + {B}_{24}}{2} + \frac{- {M}_{22} + 2 \cdot {M}_{23} - {M}_{24}}{4} & ( 4 b ) \\ {B}_{32}^{′} = \frac{{B}_{22} + {B}_{42}}{2} + \frac{- {M}_{22} + 2 \cdot {M}_{32} - {M}_{42}}{4} & ( 4 c ) \\ {B}_{33}^{′} = \frac{{B}_{22} + {B}_{42} + {B}_{24} + {B}_{44}}{4} \frac{- {M}_{22} - {M}_{24} + 4 \cdot {M}_{33} - {M}_{42} - {M}_{44}}{8} & ( 4 d )\end{matrix}$$

That is, like the coordinates (2, 2), if the signal value B_{xy} of the color that is the same as the target to be interpolated has been acquired in the mosaic image A2, that signal value B_{xy} becomes the signal value B′_{xy} as-is (Equation (4a)). Further, like the coordinates (2, 3), if pixels adjacent thereto in the x-direction in the mosaic image A2 have signals of the color that is the same as the target to be interpolated, a high spatial frequency component in the x-direction of the corresponding pixel in the monochrome image A1 is added to an average of the signal values of the adjacent pixels (Equation (4b)). Further, like the coordinates (3, 2), if pixels adjacent thereto in the y-direction in the mosaic image A2 have signals of the color that is the same as the target to be interpolated, a high spatial frequency component in the y-direction of the corresponding pixel in the monochrome image A1 is added to an average of the signal values of the adjacent pixels (Equation (4c)). Further, like the coordinates (3, 3), if pixels adjacent thereto in the x-direction and y-direction respectively in the mosaic image A2 have signal values of the color that is the same as the target to be interpolated, a high spatial frequency component in the x-direction and y-direction of the corresponding pixel in the monochrome image A1 is added to an average of the signal values of the adjacent pixels (Equation (4d)).

R-components (signal values R′_{xy}) of the interpolated image are calculated similarly.

### Modified Example 1-3

Next, the modified example 1-3 of the first embodiment of the present invention will be described. In the modified example 1-3, when color information missing in a mosaic image is interpolated, signal values of surrounding pixels used in interpolation processing are weighted according to luminance differences in a monochrome image in which the same subject image is photographed. As G-components (signal values G′_{xy}) of an interpolated image, similarly to the above described first embodiment, signal values of the monochrome image, in which the subject that is the same as that of the mosaic image is photographed, are used as-is.

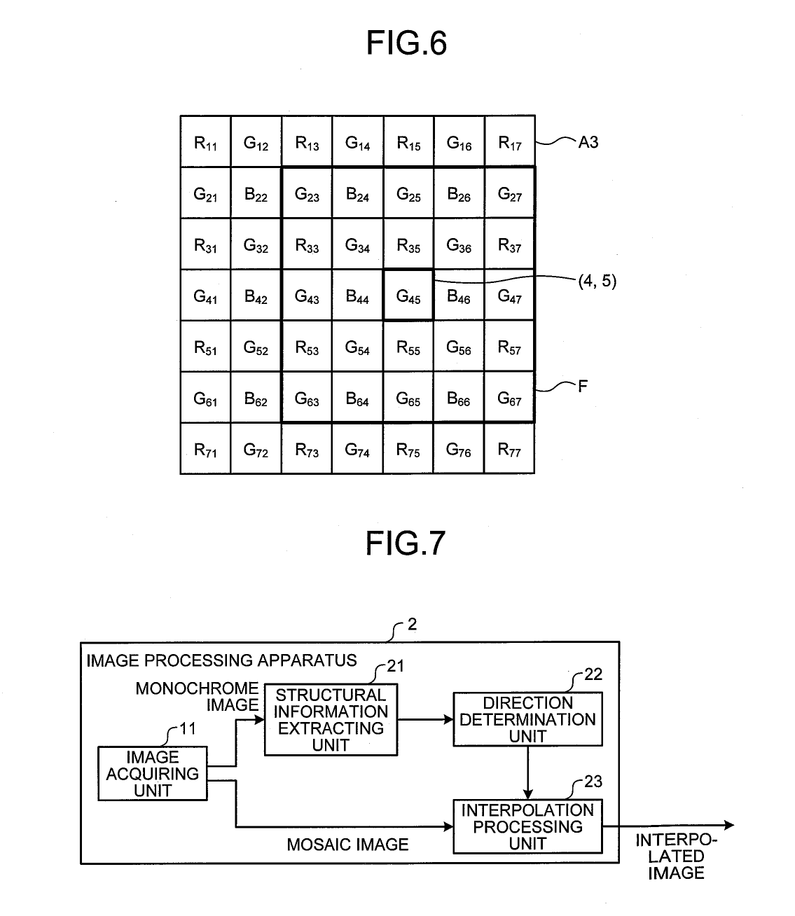

FIG. 6 is a schematic diagram illustrating image processing in the modified example 1-3 and illustrates a mosaic image formed of 7×7=49 pixels. In this mosaic image A3, a filter area “F” having a pixel to be interpolated at a center thereof is set. In the description below, a size of the filter area “F” is assumed to be 5×5 pixels, but the size of the filter area “F” may be set arbitrarily.

Subsequently, for each pixel in this filter area “F”, a weight dependent on luminance of the monochrome image is determined. If color information is of a color different from a color of the target to be interpolated, even if that color information is color information that surrounding pixels of the pixel to be interpolated have, that color information is not used. Therefore, in the filter area “F”, a weight given to a pixel having the color information of that different color is set to zero. For example, if a B-component of a pixel at coordinates (4, 5) is to be interpolated, weights of pixels such as a pixel having a signal value R₃₅ and a pixel having a signal value G₃₆ are set to zero.

Further, a weight given to a pixel having a weight of other than zero is calculated based on a luminance difference between that pixel and the pixel to be interpolated. For example, if a B-component of the pixel at the coordinates (4, 5) is to be interpolated, a weight w_{d(24)} given to a pixel having a signal value B₂₄ is given by Equation (5) below by using a signal value M₂₄ and a signal value M₄₅ in the monochrome image.

$${W}_{d ( 24 )} = \frac{1}{2 {πσ}_{d}} exp ( - \frac{{( {M}_{24} - {M}_{45} )}^{2}}{2 {σ}_{d}^{2}} ) \qquad ( 5 )$$

In Equation (5), the reference sign σ_{d} is an arbitrary value for adjusting a value of weight.

For other pixels in the filter area “F” also, weights are determined similarly.

As is clear from Equation (5), a weight w_{d(xy)} of the pixel at the coordinates (x, y) becomes greater as the luminance difference thereof from the pixel to be interpolated becomes less, and becomes less as the luminance difference becomes greater.

After determining the weight (w_{d(xy)} or zero) of each pixel in the filter area “F” as described above, by weighted summing signal values of respective pixels in the filter area “F”, each color component in an interpolated image is calculated. For example, a signal value B′₄₅ of a B-component of the pixel at the coordinates (4, 5) is given by Equation (6) below.

$${B}_{45}^{′} = \frac{{W}_{d ( 24 )} \cdot {B}_{24} + {W}_{d ( 26 )} \cdot {B}_{26} + {W}_{d ( 44 )} \cdot {B}_{44} + {W}_{d ( 46 )} \cdot {B}_{46} + {W}_{d ( 64 )} \cdot {B}_{64} + {W}_{d ( 66 )} \cdot {B}_{66}}{{W}_{d ( 24 )} + {W}_{d ( 26 )} + {W}_{d ( 44 )} + {W}_{d ( 46 )} + {W}_{d ( 64 )} + {W}_{d ( 66 )}} \qquad ( 6 )$$

R components in the interpolated image are similarly calculated.

According to the above described modified example 1-3, because weighted summing based on luminance differences between a pixel to be interpolated and respective pixels in the filter area “F” is performed, interpolation processing that keeps edges in the pixel to be interpolated is able to be performed.

### Modified Example 1-4

Next, the modified example 1-4 of the first embodiment of the present invention will be described. In the modified example 1-4, when color information missing in a mosaic image is interpolated, signal values of surrounding pixels used in interpolation processing are weighted according to luminance differences and spatial distances in a monochrome image in which the same subject image is photographed. Such weighted interpolation processing by the luminance differences and spatial distances between the pixel to be interpolated and its surrounding pixels is generally called “bilateral filter processing”. As G-components (signal values G′_{xy}) of an interpolated image, similarly to the above described first embodiment, signal values of the monochrome image, in which the subject that is the same as that of the mosaic image is photographed, are used as-is.

In the modified example 1-4 also, similarly to the modified example 1-3, first, a filter area “F” having a pixel to be interpolated at a center thereof is set for the mosaic image A3.

Subsequently, for each pixel in this filter area “F”, a weight dependent on a luminance and a spatial distance of the monochrome image is determined. Of the filter area “F”, a weight given to a pixel having color information of a color different from a color to be interpolated is set to zero.

Further, a weight given to a pixel having a weight of other than zero is calculated based on a luminance difference and a spatial distance between that pixel and the pixel to be interpolated. For example, if a B-component of the pixel at the coordinates (4, 5) is to be interpolated, a weight w₂₄ given to a pixel having a signal value B₂₄ is given by Equation (7) below.

w₂₄=w_{d(24)}×wₛ₍₂₄₎ (7)

In Equation (7), the weight w_{d(24)} is a weight based on the luminance difference between that pixel and the pixel to be interpolated and is given by Equation (5). A weight wₛ₍₂₄₎ is a weight based on the spatial distance between that pixel and the pixel to be interpolated, and is given by Equation (8) below by using a spatial difference Δx₍₂₄₋₄₅₎ in the x-direction and a spatial difference Δy₍₂₄₋₄₅₎ in the y-direction, between the coordinates (2, 4) and the coordinates (4, 5).

$${W}_{s ( 24 )} = \frac{1}{2 {πσ}_{s}} exp ( - \frac{Δ {x}_{( 24 ∼ 45 )}^{2} + Δ {y}_{( 24 ∼ 45 )}^{2}}{2 {σ}_{s}^{2}} ) \qquad ( 8 )$$

In Equation (8), the reference sign σₛ is an arbitrary value for adjusting a value of weight.

For other pixels in the filter area “F” also, weights are determined similarly.

As is clear from Equation (8), a weight w_{s(xy)} of the pixel at the coordinates (x, y): becomes greater as the spatial distance thereof from the pixel to be interpolated becomes less; and becomes less as the spatial difference becomes greater.

After determining the weight (w_{xy} or zero) of each pixel in the filter area “F” as described above, by weighted summing signal values of respective pixels in the filter area “F”, each color component in an interpolated image is calculated. For example, a signal value B′₄₅ of a B-component of the pixel at the coordinates (4, 5) is given by Equation (9) below.

$${B}_{45}^{′} = \frac{\begin{matrix}{w}_{24} \cdot {B}_{24} + {w}_{26} \cdot {B}_{26} + {w}_{44} \cdot {B}_{44} + \\ {w}_{46} \cdot {B}_{46} + {w}_{64} \cdot {B}_{64} + {w}_{66} \cdot {B}_{66}\end{matrix}}{{w}_{24} + {w}_{26} + {w}_{44} + {w}_{46} + {w}_{64} + {w}_{66}} \qquad ( 9 )$$

R components in the interpolated image are similarly calculated.

According to the above described modified example 1-4, because weighted summing based on luminance differences and spatial distances between a pixel to be interpolated and respective pixels in the filter area “F” is performed, interpolation processing that keeps edges in the pixel to be interpolated even more is able to be performed.

Other than the above described method, as the weighted interpolation based on the luminance differences and spatial distances between the pixel to be interpolated and its surrounding pixels, guided filter processing (for example, see Japanese Patent Application Laid-open No. 2012-239038), which is a known technique allowing easier and simpler calculation, may be applied.

### Modified Example 1-5

Next, the modified example 1-5 of the first embodiment of the present invention will be described.

Upon interpolation of color information missing in a mosaic image, if a pixel to be interpolated is positioned at an end portion of the mosaic image, color information of its surrounding pixels required for calculation is not available and thus the above described interpolation processing is not able to be performed.

In that case, an end portion area where color information could not be interpolated may be cut off without performing interpolation processing on the end portion area of the mosaic image. Or, by a known process for a screen end, the color information in the end portion area may be interpolated. For example, the mosaic image may be expanded by a specified method to perform interpolation processing by using signal values of pixels in the end portion area of the original mosaic image and signal values of pixels of the expanded area. As a method of expanding the mosaic image, for example, a method of filling a periphery of the mosaic image with a value of zero, a method of reproducing and periodically arranging, around the original mosaic image, the same mosaic image, a method of arranging, around the original mosaic image, the same mosaic image symmetrically (mirroring), or the like is known.

### Second Embodiment

Next, a second embodiment of the present invention will be described.

FIG. 7 is a block diagram illustrating a configuration of an image processing apparatus according to the second embodiment of the present invention. As illustrated in FIG. 1, an image processing apparatus 2 according to the second embodiment includes: the image acquiring unit 11 that acquires a monochrome image and a mosaic image in which the same subject image is photographed; a structural information extracting unit 21 that extracts structural information in the monochrome image; a direction determination unit 22 that determines, based on the structural information in the monochrome image, an interpolation direction for performing interpolation processing; and an interpolation processing unit 23 that generates an interpolated image by performing the interpolation processing on the mosaic image according to the interpolation direction determined by the direction determination unit 22. Of these, operations of the image acquiring unit 11 are similar to those of the first embodiment.

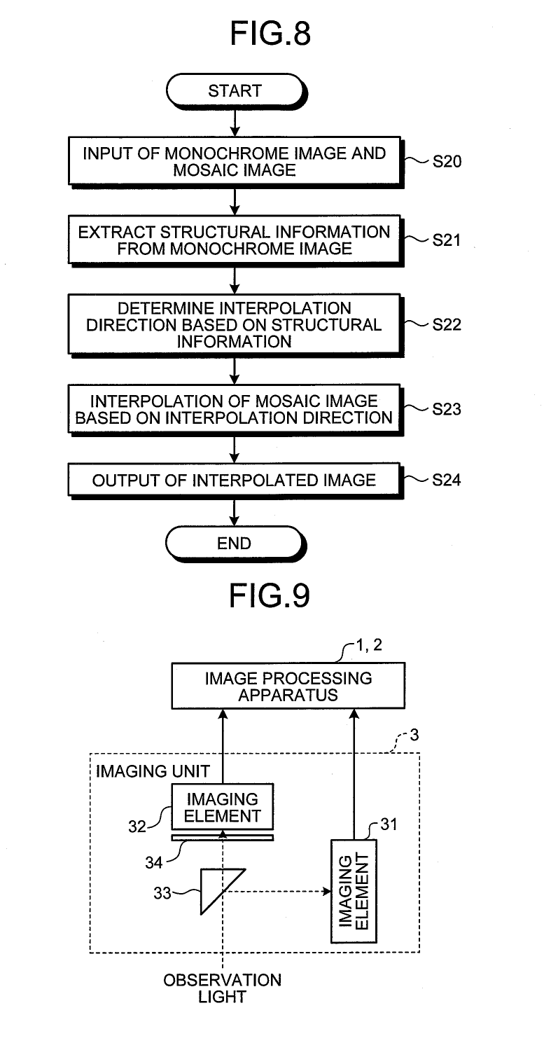

Next, operations of the image processing apparatus 2 will be described. FIG. 8 is a flow chart illustrating the operations of the image processing apparatus 2.

First, at step S20, the image acquiring unit 11 acquires a monochrome image and a mosaic image in which the same subject image is photographed, inputs the monochrome image into the structural information extracting unit 21, and inputs the mosaic image into the interpolation processing unit 23. Hereinafter, the monochrome image A1 illustrated in FIG. 3A and the mosaic image A2 illustrated in FIG. 3B are described as targets to be processed.

At subsequent step S21, the structural information extracting unit 21 extracts structural information from the monochrome image A1. The structural information used is information representing edges in the monochrome image A1, like, for example, continuity of luminance and luminance gradients. In this second embodiment, the continuity of luminance is used as the structural information. If there is a defective pixel in an imaging element that has generated the monochrome image A1, the signal value of the pixel on the monochrome image A1 corresponding to that defective pixel is interpolated beforehand by a known technique, such as linear interpolation.

If a value representing a continuity in luminance in a vertical direction (y-direction) is a and a value representing a continuity in luminance in a horizontal direction (x-direction) is β, for example, the values α and β at the coordinates (3, 3) of the monochrome image A1 are respectively given by Equations (10a) and (10b) below.

$$\begin{matrix}α = \vert \frac{{M}_{23} + {M}_{43}}{2} - {M}_{33} \vert & ( 10 a ) \\ β = \vert \frac{{M}_{32} + {M}_{34}}{2} - {M}_{33} \vert & ( 10 b )\end{matrix}$$

If these values α and β become smaller, it indicates that the continuity of luminance at the coordinates (3, 3) is high.

In addition to the vertical direction and horizontal direction, a value representing a continuity of luminance in a diagonal direction may be calculated. For example, a continuity of luminance in the diagonal direction of the coordinates (3, 3) is able to be calculated by using signal values M₂₂, M₃₃, and M₄₄ or signal values M₂₄, M₃₃, and M₄₂.

At subsequent step S22, the direction determination unit 22 determines, based on the structural information extracted in step S21, an interpolation direction for performing interpolation processing. In the second embodiment, according to the continuity of luminance, the interpolation direction is determined to be any of the horizontal direction, vertical direction, and “no direction”. In more detail, a direction in which the continuity of luminance is high is determined to be the interpolation direction.

As described above, if the values α and β representing the continuity of luminance are small, it indicates that the continuity is high. Therefore, specifically, the interpolation direction is determined as described below.

If α>β (1)

Since the value β representing the continuity in the horizontal direction is smaller, the continuity in the horizontal direction can be said to be high. Therefore, the interpolation direction is determined to be the horizontal direction.

If α<β (2)

Since that value a representing the continuity in the vertical direction is smaller, the continuity in the veridical direction can be said to be high. Therefore, the interpolation direction is determined to be the vertical direction.

If α=β (3)

The continuity in the vertical direction and the continuity in the horizontal direction can be said to be about the same. Therefore, the interpolation direction is determined to be “no direction”.

In step S21, if the structural information in the diagonal direction is extracted, the diagonal direction may be included as the interpolation direction. In any case, the direction in which the continuity is high is determined to be the interpolation direction.

At subsequent step S23, the interpolation processing unit 23 interpolates, based on the interpolation direction determined in step S22, the color information missing in the mosaic image A2, to thereby generate an interpolated image (see FIG. 4A to FIG. 4C).

To do so, first, if a defective pixel is present in an imaging element that has generated the mosaic image A2, the interpolation processing unit 23 interpolates a signal value of a pixel on the mosaic image A2 corresponding to that defective pixel.

For example, in the mosaic image A2, if a signal value R₃₃ of red at the coordinates (3, 3) is missing, that signal value R₃₃ is calculated by one of Equations (11a) to (11c) below by using signal values of the same color in its surrounding pixels according to the interpolation direction determined in step S22.

$${R}_{33} = \{ \begin{matrix}\frac{{R}_{13} + {R}_{53}}{2} & ( VERTICAL DIRECTION ) ( 11 a ) \\ \frac{{R}_{31} + {R}_{35}}{2} & ( HORIZONTAL DIRECTION ) ( 11 b ) \\ \frac{{R}_{13} + {R}_{31} + {R}_{35} + {R}_{53}}{4} & ( NO DIRECTION ) ( 11 c )\end{matrix}$$

Subsequently, the interpolation processing unit 23 calculates each color component in the interpolated image.

A signal value G′_{xy} of a G-component in the interpolated image is calculated by interpolation processing using G-signals in the mosaic image A2. For example, the signal value G′₃₃ is given by Equations (12a) to (12c) below according to the interpolation direction determined in step S22.

$${G}_{33}^{′} = \{ \begin{matrix}\frac{{G}_{23} + {G}_{43}}{2} & ( VERTICAL DIRECTION ) ( 12 a ) \\ \frac{{G}_{32} + {G}_{34}}{2} & ( HORIZONTAL DIRECTION ) ( 12 b ) \\ \frac{{G}_{23} + {G}_{32} + {G}_{34} + {G}_{43}}{4} & ( NO DIRECTION ) ( 12 c )\end{matrix}$$

Or, as expressed by Equations (13a) to (13c) below, similarly to known ACPI interpolation, a high spatial frequency component at the coordinates (2, 3) may be added.

$${G}_{33}^{′} = \{ \begin{matrix}\frac{{G}_{23} + {G}_{43}}{2} + \frac{- {R}_{13} + 2 \cdot {R}_{33} - {R}_{53}}{4} & ( VERTICAL DIRECTION ) ( 13 a ) \\ \frac{{G}_{32} + {G}_{34}}{2} + \frac{- {R}_{31} + 2 \cdot {R}_{33} - {R}_{35}}{4} & ( HORIZONTAL DIRECTION ) ( 13 b ) \\ \frac{{G}_{23} + {G}_{32} + {G}_{34} + {G}_{43}}{4} + \frac{- {R}_{13} - {R}_{31} + 4 \cdot {R}_{33} - {R}_{35} - {R}_{53}}{8} & ( NO DIRECTION ) ( 13 c )\end{matrix}$$

Further, signal values R′_{xy} and B′_{xy} of an R-component and a B-component in the interpolated image are calculated by interpolation processing using signal values of the same color in the mosaic image A2 and the signal values of the G-components in the interpolated image.

For example, signal values B′₂₂, B′₂₃, B′₃₂, and B′₃₃ of B-components are respectively given by Equations (14a) to (14d) below.

$$\begin{matrix} {B}_{22}^{′} = {B}_{22} & ( 14 a ) \\ {B}_{23}^{′} = \frac{( {B}_{22} - {G}_{22}^{′} ) + ( {B}_{24} - {G}_{24}^{′} )}{2} + {G}_{23}^{′} & ( 14 b ) \\ {B}_{32}^{′} = \frac{( {B}_{22} - {G}_{22}^{′} ) + ( {B}_{42} - {G}_{42}^{′} )}{2} + {G}_{32}^{′} & ( 14 c ) \\ {B}_{33}^{′} = \frac{( {B}_{22} - {G}_{22}^{′} ) + ( {B}_{42} - {G}_{42}^{′} ) + ( {B}_{42} - {G}_{42}^{′} ) + ( {B}_{44} - {G}_{44}^{′} )}{4} + {G}_{33}^{′} & ( 14 d )\end{matrix}$$

R components are calculated similarly.

When the signal values R′_{xy} and B′_{xy} are calculated, the modified examples 1-1 to 1-5 of the first embodiment may be applied. In that case, the signal values M_{xy} in Equations (2a) to (2d), (4a) to (4d), and (5) to (9) is replaced by the signal values G′_{xy}.

Further, if the diagonal direction is included as the interpolation direction in step S22, interpolation processing may be performed by using surrounding pixels in the diagonal direction of the pixel to be interpolated.

At subsequent step S24, the interpolation processing unit 23 causes a color image to be displayed, by outputting signals of respective color components forming the interpolated image to an external device such as a display device connected to the image processing apparatus 2. When this is done, the interpolation processing unit 23 may adjust a balance of colors in the color image by changing output intensities of the R-components, G-components, and B components color by color.

Thereafter, the operations of the image processing apparatus 2 end.

As described above, according to the second embodiment, the direction in which the spatial interpolation processing of G-components is performed is determined based on the signal values M_{xy} of the monochrome image A1, and thus accurate determination of direction becomes possible. Therefore, even at a high frequency band near the Nyquist frequency, errors in interpolation processing of G-components are able to be reduced. Further, since interpolation processing of R-components and B-components is performed by using such G-components that have been interpolation processed, generation of false colors in an interpolated image is suppressible, and an interpolated image of an image quality higher than before is able to be obtained.

### Modified Example 2-1

Next, a modified example 2-1 of the second embodiment of the present invention will be described.

In the modified example 2-1, an example in which a luminance gradient in the monochrome image A1 is used as the structural information will be described.

If luminance gradients in the horizontal direction are dₕ₁ and dₕ₂, and luminance gradients in the vertical direction are dᵥ₁ and dᵥ₂, the luminance gradients dₕ₁, dₕ₂, dᵥ₁, and dᵥ₂ are calculated by difference processing between a signal value of a pixel of interest and signal values of its surrounding pixels in the respective directions.

For example, the luminance gradients dₙ, dₕ₂, dᵥ₁, and dᵥ₂ of the pixel at the coordinates (3, 3) are given by Equations (15a) to (15d) below.

dₕ₁=|M₃₂−M₃₃| (15a)

dₕ₂=|M₃₃−M₃₄| (15b)

dᵥ₁=M₂₃−M₃₃| (15c)

dᵥ₂=|M₃₃−M₄₃| (15d)

In addition to the vertical direction and horizontal direction, a luminance gradient in the diagonal direction may be calculated.

In this case, the interpolation direction of the mosaic image A2 is determined to be a direction in which the luminance gradient is small. Specifically, the following can be said.

If (dᵥ₁+dᵥ₂)>(dₕ₁+dₕ₂) (1)

Since the luminance gradient in the horizontal direction is smaller, the interpolation direction is determined to be the horizontal direction.

If (dᵥ₁+dᵥ₂)<(dₕ₁+dₕ₂) (2)

Since the luminance gradient in the veridical direction is smaller, the interpolation direction is determined to be the vertical direction.

If (dᵥ₁+dᵥ₂)=(dₕ₁+dₕ₂) (3)

Since the luminance gradients in the horizontal direction and vertical direction are equal to each other, it is determined that the interpolation direction has no directionality.

### Third Embodiment

Next, a third embodiment of the present invention will be described.

FIG. 9 is a schematic diagram illustrating an example of a configuration of an imaging apparatus according to the third embodiment of the present invention. As illustrated in FIG. 9, the imaging apparatus according to the third embodiment includes: the image processing apparatus 1 or 2; and an imaging unit 3 that generates an image signal based on observation light of a subject (reflected light, transmitted light, and the like from the subject when illumination light is irradiated to the subject) and inputs the image signal into the image processing apparatus 1 or 2. The configuration and operations of the image processing apparatus 1 or 2 are similar to those of the first or second embodiment.

The imaging unit 3 includes: two imaging elements 31 and 32; a prism 33 as an optical system that divides the observation light of the subject to be guided respectively in directions of the imaging elements 31 and 32; and a color filter 34 provided in one of the imaging elements, which is the imaging element 32.

The imaging elements 31 and 32 are solid-state imaging elements formed of CCD image sensors or the like, for example, and each have a plurality of pixels arranged at a pitch equal to the other. The imaging elements 31 and 32 generate image signals by photoelectrically converting the observation light of the subject received at light receiving surfaces they respectively have, and output the image signals to the image processing apparatus 1 or 2. These imaging elements 31 and 32 are preferably controlled to execute imaging operations simultaneously.

The imaging elements 31 and 32 may include therein amplifiers that amplify the image signals generated by the photoelectric conversion or an amplifier may be separately provided downstream from the imaging elements 31 and 32. Further, an A/D converter may be provided downstream from the imaging elements 31 and 32 to input image data digitalized of the image signals to the image processing apparatus 1 or 2, or the analog image signals may be input to the image processing apparatus 1 or 2 to digitalize these image signals at an image processing apparatus 1 or 2 side.

The color filter 34 is an optical member, in which respective filters are arranged at a position corresponding to pixels of the imaging elements 32, and is provided on the light receiving surface of the imaging element 32. The imaging element 32 outputs the image signals representing color information of the colors determined pixel by pixel by receiving the observation light via the color filter 34.

The color filter 34 used may be any of various know color filters. Specifically, it may be: a Bayer array type color filter in which one red color filter, two green color filters, and one blue color filter are arranged in a pixel area of two lines and two columns; a complementary color filter in which one each of cyan, magenta, yellow, and green filters are arranged in a pixel area of two lines and two columns; a multiband filter in which eight green color filters, two cyan filters, two orange filters, two blue color filters, and two red color filters are arranged in a pixel area of four lines and four columns (see, for example, Japanese Patent Application Laid-open No. 2012-239038); or the like.

The observation light incident on the imaging unit 3 is divided by the prism 33, one of the divided beams of observation light is caused to be incident on the imaging element 31, and the other one of the divided beams of observation light is caused to be incident on the imaging element 32 via the color filter 34. Thereby, image signals of a monochrome image are generated in the imaging element 31, image signals of a mosaic image are generated in the imaging element 32, and these generated image signals are both output to the image processing apparatus 1 or 2.

The pixel pitch of the imaging element 31 that generates the image signals of the monochrome image may be smaller than the pixel pitch of the imaging element 32 that generates the image signals of the mosaic image. In this case, a spatial correspondence relationship between each pixel of the imaging element 32 and one or more pixels of the imaging element 31 corresponding thereto is acquired beforehand.

Further, the observation light may be divided by using a half mirror instead of the prism 33.

### Modified Example 3-1

Next, a modified example 3-1 of the third embodiment of the present invention will be described. A configuration of an imaging unit that generates an image signal input to the image processing apparatus 1 or 2 is not limited to the configuration of the imaging unit 3 described in the third embodiment.

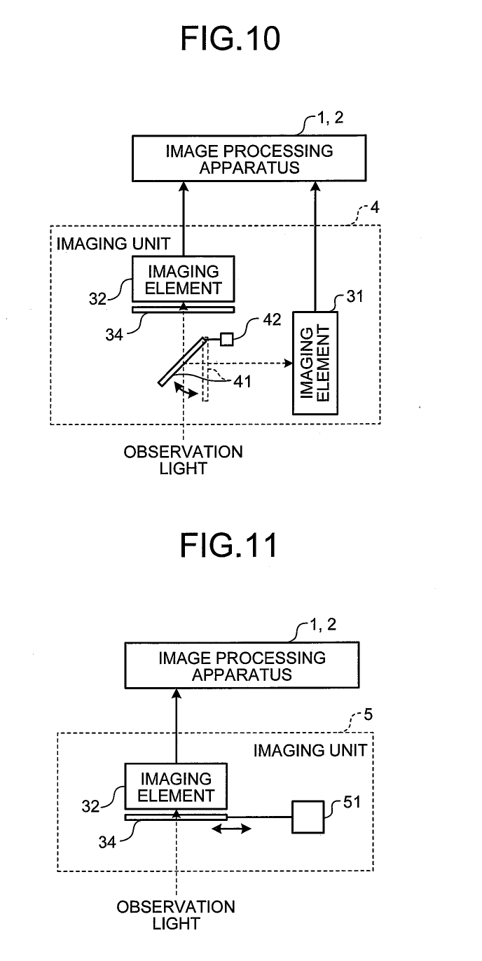

FIG. 10 is a schematic diagram illustrating a configuration of an imaging apparatus according to the modified example 3-1. As illustrated in FIG. 10, the imaging apparatus according to the modified example 3-1 includes: the image processing apparatus 1 or 2; and an imaging unit 4 that generates an image signal based on observation light of a subject and inputs the image signal to the image processing apparatus 1 or 2.

The imaging unit 4 includes: the two imaging elements 31 and 32; a reflecting mirror 41 and a mirror drive unit 42, which are an optical system that guides the observation light of the subject to the imaging elements 31 and 32 in a time-divided manner; and a color filter 34 that is provided in the imaging element 32. Of these, the configurations and operations of the imaging elements 31 and 32 and the configuration and actions of the color filter 34 are similar to those of the third embodiment.

The mirror drive unit 42 switches over, by driving the reflecting mirror 41 at a specified cycle, between a state in which the reflecting mirror 41 is arranged on an optical path of the observation light that enters the imaging unit 4 and goes straight and a state in which the reflecting mirror 41 is removed from the optical path.

As indicated by a solid line, when the reflecting mirror 41 is arranged on the optical path of the observation light, the observation light is reflected by the reflecting mirror 41 and enters the imaging element 31. In contrast, as indicated by a broken line, when the reflecting mirror 41 is removed from the optical path of the observation light, the observation light goes straight and enters the imaging element 32 via the color filter 34.

By sequentially causing the observation that has entered the imaging unit 3 to be incident on the imaging element 31 and imaging element 32 by the reflecting mirror 41 and mirror drive unit 42, image signals of a monochrome image and mage signals of a mosaic image are sequentially generated and sequentially output to the image processing apparatus 1 or 2 from the imaging unit 4.

### Modified Example 3-2

Next, a modified example 3-2 of the third embodiment of the present invention will be described. In this modified example 3-2, yet another configuration of an imaging unit that generates an image signal to be input to the image processing apparatus 1 or 2 will be described.

FIG. 11 is a schematic diagram illustrating a configuration of an imaging element according to the modified example 3-2. As illustrated in FIG. 11, an imaging apparatus according to the modified example 3-2 includes: the image processing apparatus 1 or 2; and an imaging unit 5 that generates an image signal based on observation light of a subject and inputs the image signal to the image processing apparatus 1 or 2.

The imaging unit 5 includes: the imaging element 32; the color filter 34 that is provided insertably and removably upstream of the light receiving surface of the imaging element 32; and a filter drive unit 51 that drives the color filter 34. Of these, the configuration of the imaging element 32 and the configuration and actions of the color filter 34 are the same as those of the third embodiment.

The filter drive unit 51 inserts and removes the color filter 34 in and from an optical path of observation light at a specified cycle. FIG. 11 illustrates a state in which the color filter 34 has been inserted in the optical path of the observation light. When the color filter 34 is inserted in the optical path of the observation light, the imaging element 32 generates an image signal of a mosaic image by receiving the observation light via the color filter 34. On the contrary, when the color filter 34 has been removed from the optical path of the observation light, the imaging element 32 generates an image signal of a monochrome image by directly receiving the observation light.

By such operations of the filter drive unit 51, the image signals of the monochrome image and the image signals of the mosaic image are sequentially generated in the imaging element 32 and output from the imaging unit 5 to the image processing apparatus 1 or 2.

### Fourth Embodiment

Next, a fourth embodiment of the present invention will be described.

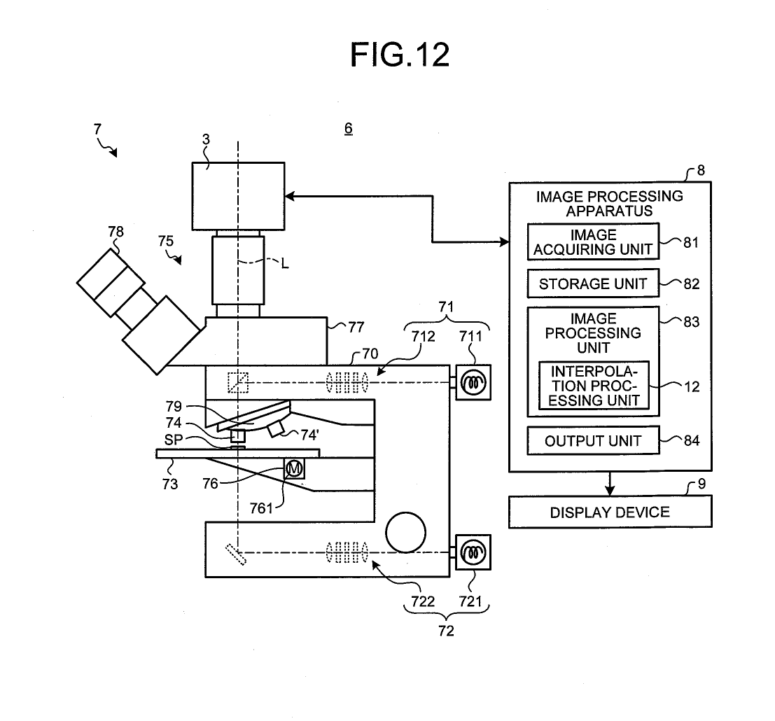

FIG. 12 is a diagram illustrating a configuration of a microscope system according to the fourth embodiment of the present invention. As illustrated in FIG. 12, a microscope system 6 according to this fourth embodiment includes: a microscope apparatus 7 to which the imaging unit 3 is attached; an image processing apparatus 8 that performs image processing on an image generated in the imaging unit 3; and a display device 9 that displays the image on which the image processing has been performed in the image processing apparatus 8. Of these, the configuration and operations of the imaging unit 3 are similar to those of the third embodiment (see FIG. 9). Instead of the imaging unit 3, the imaging unit 4 (see FIG. 10) or the imaging unit 5 (see FIG. 11) may be applied.

The microscope apparatus 7 includes: an approximately C-shaped arm 70 in which epi-illumination unit 71 and transmitted-light illumination unit 72 are provided; a specimen stage 73, which is attached to the arm 70 and on which a specimen SP to be observed is placed; an objective lens 74, which is provided to face the specimen stage 73 at one end side of a lens barrel 75 via a trinocular lens barrel unit 77; a stage position changing unit 76 that moves the specimen stage 73; and an eyepiece unit 78, which is used when a user directly observes the specimen SP. The imaging unit 3 is provided at another end side of the lens barrel 75 and the trinocular lens barrel unit 77 branches observation light of the specimen SP incident from the objective lens 74 into the imaging unit 3 and eyepiece unit 78.

The epi-illumination unit 71 includes an epi-illumination light source 711 and an epi-illumination optical system 712 to irradiate the specimen SP with epi-illumination light. The epi-illumination optical system 712 includes various optical members (a filter unit, a shutter, a field stop, an aperture diaphragm, and the like) that condense, and guide in a direction of the observation optical path L, illumination light emitted from the epi-illumination light source 711.

The transmitted-light illumination unit 72 includes a transmitted-light illumination light source 721 and a transmitted-light illumination optical system 722 to irradiate the specimen SP with transmitted-light. The transmitted-light illumination optical system 722 includes various optical members (a filter unit, a shutter, a field stop, an aperture diaphragm, and the like) that condense, and guide in the direction of the observation optical path L, illumination light emitted from the transmitted-light illumination light source 721.

The objective lens 74 is attached to a revolver 79 that is able to hold a plurality of objective lenses (for example, the objective lens 74 and an objective lens 74′) having magnifications different from one another. By rotating this revolver 79 to change the objective lenses 74 and 74′ facing the specimen stage 73, an imaging magnification is able to be changed.

Inside the lens barrel 75, a zoom unit, which includes: a plurality of zoom lenses; and a drive unit that changes positions of these zoom lenses (both of which are not illustrated), is provided. The zoom unit magnifies or reduces a subject image within an imaging field by adjusting the position of each zoom lens.

The stage position changing unit 76 includes, for example, a motor 761 and changes the imaging field by moving a position of the specimen stage 73 within an XY plane. Further, the stage position changing unit 76 matches a focal point of the objective lens 74 to the specimen SP by moving the specimen stage 73 along a Z-axis.

The image processing apparatus 8 includes an image acquiring unit 81, a storage unit 82, an image processing unit 83, and an output unit 84. Of these, a configuration and operations of the image acquiring unit 81 are similar to those of the image acquiring unit 11 illustrated in FIG. 1.

The storage unit 82 is composed of: a recording device such as a semiconductor memory like a rewritable flash memory, a RAM, or a ROM; or a recording device or the like that includes a recording medium such as a hard disk, an MO, a CD-R, or a DVD-R, which is built-in or connected by a data communication terminal, and a read and write device that reads and writes information from and to the recording medium. The storage unit 82 stores therein a control program for controlling operations of the image processing apparatus 8, various parameters and setting information used during execution of the control program, image signals of a monochrome image and a mosaic image acquired by the image acquiring unit 81, image signals of an image (interpolated image or the like) subjected to image processing by the image processing unit 83, and the like.

The image processing unit 83 includes the interpolation processing unit 12 that generates an interpolated image based on image signals of a monochrome image and a mosaic image acquired by the image acquiring unit 81, as described in the first embodiment. Or, the image processing unit 83 may be composed of, similarly to the second embodiment, the structural information extracting unit 21, the direction determination unit 22, and the interpolation processing unit 23.

In the fourth embodiment, the image processing unit 83 may be composed of dedicated hardware or configured by loading a specified program into hardware such as a CPU. In the latter case, the storage unit 82 further stores therein an image processing program for causing the image processing unit 83 to execute image processing including processing to generate an interpolated image and various parameter and setting information used during execution of that image processing program.

The output unit 84 is an external interface for connecting an external device such as the display device 9 to the image processing apparatus 8.

The display device 9 is composed of, for example, a display device such as an LCD, an EL display, or a CRT display, and displays a color image based on image data of an interpolated image output from the image processing apparatus 8.

According to some embodiments, based on a signal value of each pixel forming a monochromatic image, color information missing in each pixel forming a color image is interpolated, and thus errors cased by interpolation processing are reduced and suppression of generation of false colors is possible even at a high frequency band near the Nyquist frequency.

The present invention is not limited to the above described first to fourth embodiments and modified examples as-is and by combining a plurality of elements disclosed in the respective first to fourth embodiments and modified examples as appropriate, various inventions may be formed. For example, some of the elements from all of the elements disclosed in the first to fourth embodiments and modified examples may be excluded. Or, the elements disclosed in different embodiments may be combined as appropriate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus, comprising:
an image acquiring unit that acquires an image signal of a monochromatic image acquired by imaging a subject and an image signal of a color image acquired by imaging the subject, the color image having at least a plurality of pieces of color information; and
an interpolation processing unit that generates an interpolated image by interpolating color information missing at each pixel forming the color image, based on a signal value of each pixel forming the monochromatic image.

2. The image processing apparatus according to claim 1, wherein the interpolation processing unit interpolates the missing color information, by using the signal value of each pixel forming the monochromatic image as luminance information.

3. The image processing apparatus according to claim 2, wherein
the color image is an image in which a plurality of pixels having color information of any of red, blue, and green are arranged, and
the interpolation processing unit:
uses the luminance information as green color information in the interpolated image; and
calculates red color information and blue color information in the interpolated image by using: the signal value of each pixel forming the monochromatic image; a signal value of a pixel having color information of red from the pixels forming the color image; and a signal value of a pixel having color information of blue from the pixels forming the color image.

4. The image processing apparatus according to claim 2, wherein
the color image is an image in which a plurality of pixels having color information of any of red, blue, and green are arranged, and
the interpolation processing unit:
uses the luminance information as a luminance component in a YCbCr color space; and
calculates a color difference component in the YCbCr color space by using: the signal value of each pixel forming the monochromatic image; a signal value of a pixel having color information of red from the pixels forming the color image; and a signal value of a pixel having color information of blue from the pixels forming the color image.

5. The image processing apparatus according to claim 1, further comprising:
a structural information extracting unit that extracts structural information in the monochromatic image based on the signal value of each pixel forming the monochromatic image; and
a direction determination unit that determines an interpolation direction for performing interpolation processing based on the structural information, wherein
the interpolation processing unit interpolates the missing color information by performing the interpolation processing according to the interpolation direction determined by the direction determination unit.

6. The image processing apparatus according to claim 5, wherein the structural information is information representing a continuity or a gradient between the signal value of each pixel forming the monochrome image and signal values of surrounding pixels of the each pixel.

7. An imaging apparatus, comprising:
the image processing apparatus according to claim 1; and
an imaging unit that generates and outputs the image signals of the color image and monochromatic image by imaging the subject.

8. The imaging apparatus according to claim 7, wherein the imaging unit includes:
two imaging elements that generate image signals corresponding to incident light;
a color filter provided on a light receiving surface of one of the two imaging elements; and
an optical system that divides observation light of the subject and guides the divided observation light respectively into directions of the two imaging elements, or sequentially guides the observation light to directions of the two imaging elements.

9. The imaging apparatus according to claim 8, wherein the two imaging elements have pixel pitches that are equal to each other.

10. A microscope system, comprising:
the imaging apparatus according to claim 7;
a stage on which the subject is configured to be placed; and
an optical system that guides observation light of the subject to the imaging apparatus.

11. An image processing method, comprising the steps of:
acquiring an image signal of a monochromatic image acquired by imaging a subject and an image signal of a color image acquired by imaging the subject, the color image having at least a plurality of pieces of color information; and
generating an interpolated image by interpolating color information missing at each pixel forming the color image, based on a signal value of each pixel forming the monochromatic image.

12. A non-transitory computer readable recording medium having an image processing program recorded therein, the image processing program instructing a processor to perform the steps of:
acquiring an image signal of a monochromatic image acquired by imaging a subject and an image signal of a color image acquired by imaging the subject, the color image having at least a plurality of pieces of color information; and
generating an interpolated image by interpolating color information missing at each pixel forming the color image, based on a signal value of each pixel forming the monochromatic image.
